(19) United States
(12) Patent Application Publication
(10) Pub. No.: US 2009/0136238 A1
(43) Pub. Date: May 28, 2009

(54) Security over an optical fiber link

(76) Inventors: Douglas M. Gill, South Orange, NJ (US); Xiang Liu, Marlboro, NJ (US)

Correspondence Address: Alcatel-Lucent, Docket Administrator-Room 2F-192, 600 Mountain Avenue, Murray Hill, NJ, 07974-0636, US

(21) Appl. No.: 12/286,024

(22) Filed: Sep. 26, 2008

Related U.S. Application Data
(60) Provisional application No. 60/995,529, filed on Sep. 26, 2007.

(51) Int. Cl. H04B 10/12; H04B 10/04; H04B 10/00

(52) U.S. Cl. 398/141; 398/188; 398/159

(57) ABSTRACT

An apparatus includes an optical transmitter having a first dynamically reconfigurable optical filter, an optical receiver having a second dynamically reconfigurable optical filter. The optical transmitter and optical receive are connected via an optical fiber transmission line. The optical filters are configured to function in a complementary manner.

This application claims the benefit of U.S. provisional patent application No. 60/995,529, filed Sep. 26, 2007 by Douglas M. Gill and Xiang Liu.

### BACKGROUND

1. Technical Field

The invention relates generally to optical apparatus and methods and, more particularly, to apparatus and methods for optically communicating data.

2. Discussion of the Related Art

There are a variety of techniques that provide security by encrypting data. The encrypted data may be transmitted over conventional communication media where the encrypted data can be intercepted. The content of such intercepted encrypted data may, however, be decrypted later if the intercepted encrypted data can be stored, and the key for the encryption is obtained later.

Code-division multiple access (CDMA) protocols provide additional security to wireless data communications. But, CDMA protocols have been less used for providing security to optical data communications.

### SUMMARY

In various embodiments, an optical transmitter and an optical receiver are configured to process modulated optical carrier signals with complementary optical filters. The processing can provide security to transmitted data via analog optical scrambling.

An embodiment of an apparatus includes an optical transmitter having a first dynamically reconfigurable optical filter, an optical receiver having a second dynamically reconfigurable optical filter. The optical transmitter and optical receive are connected via an optical fiber transmission line. The dynamically reconfigurable optical filters are configured to function in a complementary manner.

In some specific embodiments of the above apparatus, one of the dynamically reconfigurable optical filters has a free spectral range that is less than the data symbol rate of the optical transmitter.

In some specific embodiments of above apparatus, one of the dynamically reconfigurable optical filters has a frequency response function that varies substantially over the full bandwidth at 3 decibel attenuation of a data-modulated optical carrier signal produced by the optical transmitter.

In some specific embodiments of above apparatus, one of the dynamically reconfigurable optical filters has a frequency response function that can be substantially dynamically varied over the full bandwidth at 3 decibel attenuation of a data-modulated optical carrier signal produced by the optical transmitter.

In some specific embodiments of above apparatus, the optical transmitter is configured transmit filter-configuration keys to the optical receiver.

In some other specific embodiments of above apparatus, the optical receiver is configured transmit filter-configuration keys to the optical transmitter.

Some yet other specific embodiments of the above apparatus include an external controller configured to transmit filter-configuration keys to the optical transmitter and the optical receiver. In such embodiments, the optical transmitter and the optical receiver are configured to reconfigure the dynamically reconfigurable optical filter thereof in response to receiving one of the filter-configuration keys from the external controller.

In some specific embodiments of above apparatus, one of the dynamically reconfigurable optical filters includes a Mach-Zehnder interferometer with an internal optical waveguide that is a dynamically variable optical delay line.

In some specific embodiments of above apparatus, one of the dynamically reconfigurable optical filters includes an optical splitter, an optical combiner and first and second internal optical waveguides. In such specific embodiments, the first internal optical waveguide connects an output of the optical splitter to an input of the optical combiner, and the second internal optical waveguide is a variable optical delay line connecting an output of the optical combiner to an input of the optical splitter.

In some specific embodiments of above apparatus, one of the dynamically reconfigurable optical filters is able to generate a phase ripple having a peak-to-peak phase variation of a ½ radian or more.

An embodiment of a method of communicating optically includes, at a data symbol rate, modulating data symbols onto an optical carrier according to a phase-keyed modulation protocol. The modulating sequentially produces portions of a modulated optical carrier signal. The method includes sequentially passing the portions of the modulated optical carrier signal through a first dynamically reconfigurable optical filter to sequentially produce portions of a distorted modulated optical carrier signal. The method includes sequentially transmitting the portions of the distorted modulated optical carrier signal to an optical fiber transmission line. The method includes sequentially passing portions of the distorted modulated optical carrier signal through a second dynamically reconfigurable optical filter in response to receiving the portions in an optical receiver connected to the optical fiber transmission line. The first and second dynamically reconfigurable optical filters are configured to function in complementary manners.

In some specific embodiments of the above method, one of the dynamically reconfigurable optical filters has a free spectral range that is less than the data symbol rate.

In some specific embodiments of above methods, one of the dynamically reconfigurable optical filters has a frequency response function that varies substantially over the full bandwidth at 3 decibel attenuation of the modulated carrier signal produced by the optical transmitter.

In some specific embodiments, the above method further includes reconfiguring the dynamically reconfigurable optical filter of one of the optical transmitter and the optical receiver to have a new frequency response function, and reconfiguring the dynamically reconfigurable optical filter of the other of the optical transmitter and the optical receiver to have a new frequency response function. The reconfigured dynamically reconfigurable optical filter of the optical transmitter is complementary to the reconfigured dynamically reconfigurable optical filter of the optical receiver. Some more specific embodiments also include transmitting a filter-configuration key from the one of the optical transmitter and the optical receiver to the other of the optical transmitter and the optical receiver, wherein the reconfiguring of the dynamically reconfigurable optical filter of the other of the optical transmitter and the optical receiver is performed responsive to receiving the filter-configuration key in the other of the optical transmitter and the optical receiver.

In some alternate more specific embodiments, the reconfiguring steps are performed in response to receiving filter-configuration keys from an external controller at the optical transmitter and the optical receiver.

Some other more specific embodiments further include repeating the modulating, passing, and transmitting acts while the dynamically reconfigurable optical filters are reconfigured.

In some specific embodiments of above methods, each dynamically reconfigurable optical filter includes a Mach-Zehnder interferometer with an internal optical waveguide that is a dynamically variable optical delay line.

In some specific embodiments of above methods, each dynamically reconfigurable optical filter includes an optical splitter, an optical combiner and first and second internal optical waveguides. The first internal optical waveguide connects an output of the optical splitter to an input of the optical combiner. The second internal optical waveguide is a variable optical delay line connecting an output of the optical combiner to an input of the optical splitter.

In some specific embodiments of above methods, one of the dynamically reconfigurable optical filters is configured to generate a phase ripple having a peak-to-peak phase variation of a ½ radian or more.

### BRIEF DESCRIPTION OF THE FIGURES

FIG. 1A illustrates one optical data communication system that performs coordinated analog optical scrambling and unscrambling and that includes an external scrambling-controller that coordinates analog optical scrambling and unscrambling;

FIG. 1C illustrates yet another optical communication system that performs coordinated analog optical scrambling and unscrambling via preselected assignments of filter-configuration keys to the optical transmitter and the optical receiver;

FIG. 2A qualitatively illustrates a potential form for ripple distortion in which an optical filter would produce satellite copies of each optical pulse of a modulated optical carrier signal to provide analog optical scrambling, e.g., in some optical transmitters of FIGS. 1A-1C;

FIG. 2B qualitatively illustrates a potential form for ripple distortion in which an optical filter would produce a finite series of satellite copies of each optical pulse of a modulated optical carrier signal to provide analog optical scrambling, e.g., in some optical transmitters of FIGS. 1A-1C;

FIG. 2C qualitatively illustrates a potential form for ripple distortion in which an optical filter produces a long series of satellite copies of each optical pulse of a modulated optical carrier signal to provide analog optical scrambling, e.g., in some embodiments of optical transmitters of FIGS. 1A-1C;

FIG. 3 qualitatively illustrates a useful relation between free spectral ranges (FSR) of the dynamically reconfigurable optical filters in FIGS. 1A-1C and the data bandwidths (DBW) of the data symbol-modulated optical carrier signals therein;

FIG. 4A is a block diagram illustrating a single-stage dynamically reconfigurable optical filter that may be used for analog optical scrambling and unscrambling of data-modulated optical carrier signals in the optical communications systems of FIGS. 1A-1C;

FIG. 4B is a block diagram illustrating a dynamically reconfigurable optical filter that serially cascades two dynamically reconfigurable optical filters and that may provide analog optical scrambling and unscrambling of data-modulated optical carrier signals, e.g., in the optical communications systems of FIGS. 1A-1C;

FIG. 4C is a block diagram illustrating another dynamically reconfigurable optical filter that serially cascades two dynamically reconfigurable optical filters and that may provide analog optical scrambling and unscrambling of data-modulated optical carrier signals, e.g., in the optical communications systems of FIGS. 1A-1C;

FIG. 4D is a block diagram illustrating an alternate dynamically reconfigurable optical filter that uses optical feedback and that may provide analog optical scrambling and unscrambling of data-modulated optical carrier signals, e.g., in the optical communications systems of FIGS. 1A-1C;

FIG. 5A is a flow chart illustrating an optical communication method that uses analog optical scrambling, e.g., in optical communications systems of FIGS. 1A-1C;

FIG. 5B is a flow chart illustrating an embodiment of the optical communication method of FIG. 5A that dynamical reconfigures the analog optical scrambling; and

FIG. 6 is a block diagram illustrating a two-stage dynamically reconfigurable optical filter that may provide analog optical scrambling and unscrambling based on low amplitude ripple, e.g., in optical communications systems of FIGS. 1A-1C.

In the Figures and text like reference numbers refer to functionally similar elements.

In the Figures, the relative dimensions of some features may be exaggerated to more clearly illustrate apparatus therein.

Herein, various embodiments are described more fully by the Figures and the Detailed Description of Illustrative Embodiments. Nevertheless, the invention(s) may be embodied in various forms and are not limited to the specific embodiments described in the Figures and Detailed Description of Illustrative Embodiments.

### DESCRIPTION OF THE ILLUSTRATIVE EMBODIMENTS

This application incorporates herein by reference, in its entirety, U.S. provisional patent application No. 60/995,529 filed on Sep. 26, 2007.

Herein, dynamically reconfigurable and dynamically adjustable refers to an ability to reconfigure at a plurality of times and an ability to adjust at a plurality of times, respectfully, e.g., in response to receipt of commands during operation to perform reconfigurations or adjustments or during operation in the absence of such commands.

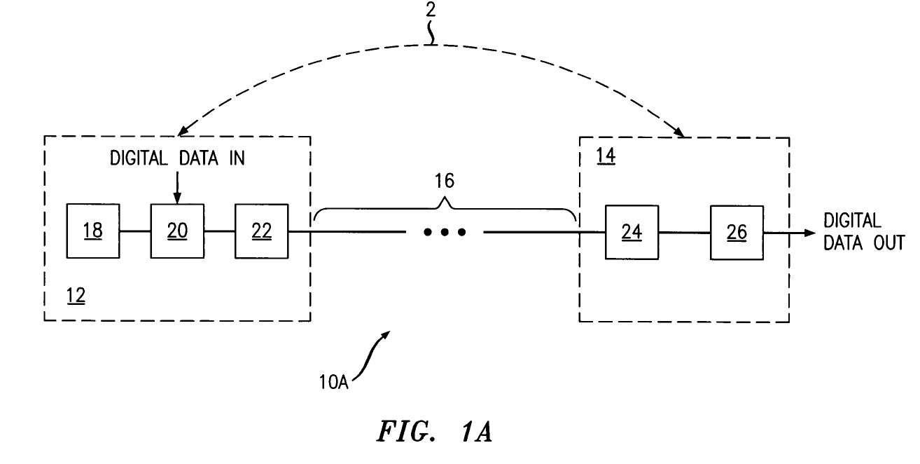

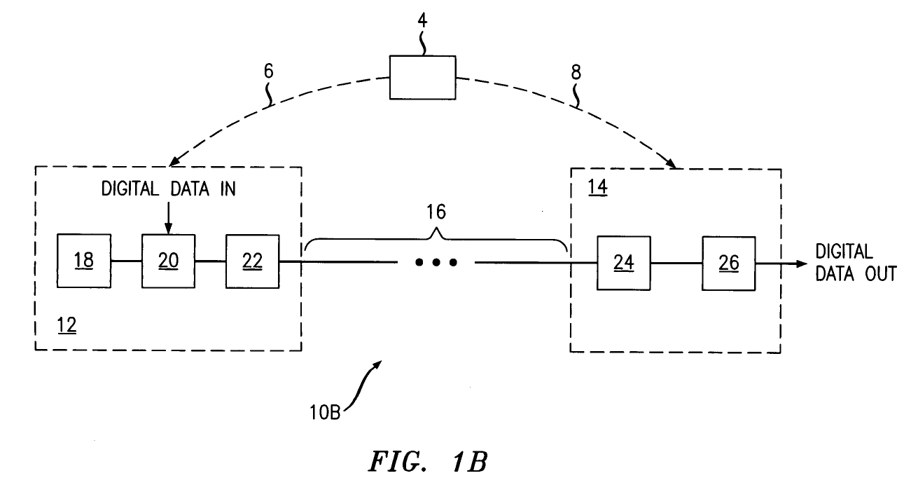

FIGS. 1A-1C illustrate three alternate embodiments 10A, 10B, 10C of optical communication systems that implement scrambling techniques for providing analog security to optical data over an all-optical link. Each optical communications system 10A, 10B, 10C includes an optical transmitter 12, an optical receiver 14, and an all-optical fiber transmission line 16 optically connecting the optical transmitter 12 to the optical receiver 14. Some of the optical communication systems 10A, 10B include another channel for communicating synchronization data to the optical transmitter 12 and/or the optical receiver 14.

Along the all-optical fiber transmission line 16, an eavesdropper may be able to intercept data-carrying optical signals sent between the optical transmitter 12 and the optical receiver 14. To provide security to such intercepted data, the optical transmitter 12 uses analog optical scrambling, and the optical receiver 14 removes the scrambling via analog optical unscrambling as discussed below.

The optical transmitter 12 includes a light source 18, an optical modulator 20, and a dynamically reconfigurable optical filter 22.

The light source 18 produces an optical carrier. One example of the light source 18 is a conventional continuous-wave (CW) laser that produces a monochromatic continuous-waved (CW) optical carrier at a wavelength in the telecommunications C and/or L bands. Another example of a light source 18 produces an optical carrier in one of the above telecommunications bands with a sequence of regularly spaced and identical optical pulses thereon, e.g., to implement an optical return-to-zero (RZ) format.

The optical modulator 20 sequentially modulates data of a received digital data stream onto the optical carrier received from the light source 18 thereby producing a data symbol-modulated optical carrier signal. The modulation is performed according to any conventional phase and/or amplitude optical modulation scheme. Exemplary optical modulation schemes include quadrature phase key shifting (QPSK) schemes such as 4-QPSK, 8-QPSK, 16-QPSK, 32-QPSK, 64-QPSK, and differential versions thereof.

The optical modulator 20 may be any of a variety of optical modulators that phase and/or amplitude modulate a stream of digital data onto an optical carrier, e.g., conventional optical modulators. Examples of suitable optical modulators may be described in U.S. Patent Application Publication Nos.: 20050238367, 20070036555, and/or 20070071456, which are all incorporated herein by reference in their entirety.

The dynamically reconfigurable optical filter 22 produces an analog phase and/or amplitude distortion on the modulated optical carrier signal received from the optical modulator 20. The phase and/or amplitude distortion can scramble a portion of the optical data stream prior to its transmission to the all-optical fiber transmission path 16. Such analog optical scrambling may make the data symbol stream modulated onto the optical carrier less easily demodulated if intercepted by an eavesdropper during on the all-optical fiber transmission path 16. To improve the data security, the dynamically reconfigurable optical filter 22 may differently scramble different sequential portions of the modulated optical carrier signal, i.e., with different filter responses. The times at which the form of the scrambling changes may be prescheduled or externally provoked.

The optical receiver 14 includes a second dynamically reconfigurable optical filter 24 and an optical data demodulator 26.

In the receiver 14, the dynamically reconfigurable optical filter 24 is configured to produce a distortion of the data-modulated optical carrier signal that is complementary to the analog distortion produced thereon by the dynamically reconfigurable optical filter 22 of the optical transmitter 12. That is, the dynamically reconfigurable optical filter 24 is configured to substantially remove the analog optical scrambling from the dynamically reconfigurable optical filter 22 of the optical transmitter 12. For example, the dynamically reconfigurable optical filters 22, 24 may have substantially inverse frequency responses over the used optical communications wavelength(s).

The dynamically reconfigurable optical filters 22, 24 of the optical receiver are reconfigured in a coordinated manner so as to act on individual temporal portions of the data-modulated optical carrier signal in substantially complementary manners. When the optical transmitter's dynamically reconfigurable optical filter 22 is reconfigured to have a new filter response, the optical receiver's dynamically reconfigurable optical filter 24 is reconfigured with a new filter response that is complementary to the new filter response of the dynamically reconfigurable optical filter 22. For that reason, the optical receiver 14 can unscramble the analog optical unscrambling performed in the optical transmitter 12 even when the form of such analog optical scrambling changes in time.

In the optical receiver 14, the optical data demodulator 26 produces a demodulated digital data stream from the data symbol-modulated optical carrier signal produced by the dynamically reconfigurable optical filter 24. That is, the optical demodulator 26 operates on a modulated optical carrier signal that is substantially free of analog optical scrambling, e.g., approximately up to nonlinear optical effects and uncompensated optical dispersion, optical signal interference, and optical attenuation. The optical data demodulator 26 outputs, e.g., a sequence of electronic data symbols that are estimates of the sequence of data symbols modulated onto the optical carrier by the optical modulator 20.

The optical data demodulator 26 may include a variety of optical demodulators, e.g., conventional apparatus. Examples of suitable apparatus for optical demodulators 20 may be described in one or more of U.S. Patent Application Publications: 20050238367, 20070036555, and 20070071456. The optical data demodulator 26 may also include conventional electronic circuitry and/or software for performing error correction and/or data decompression of the digital data stream generated by such apparatus.

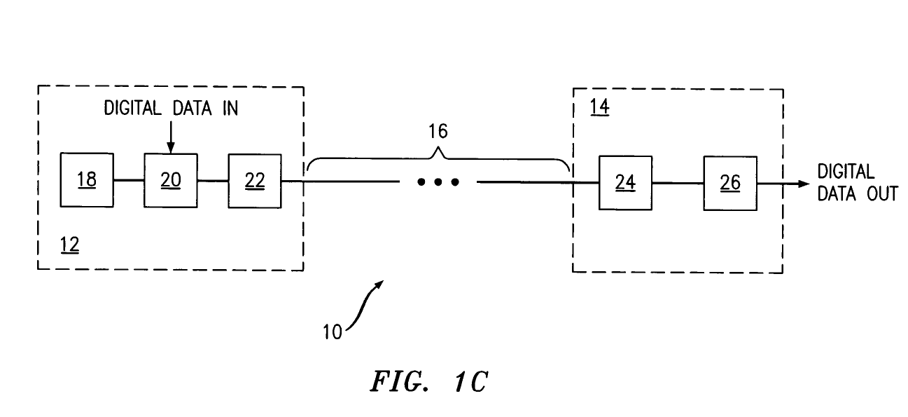

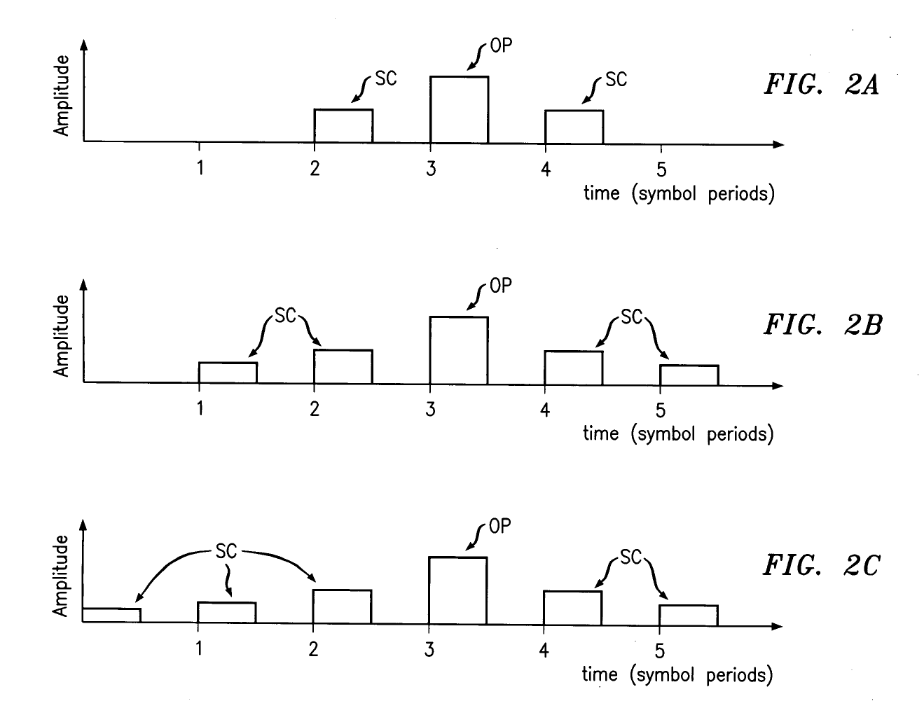

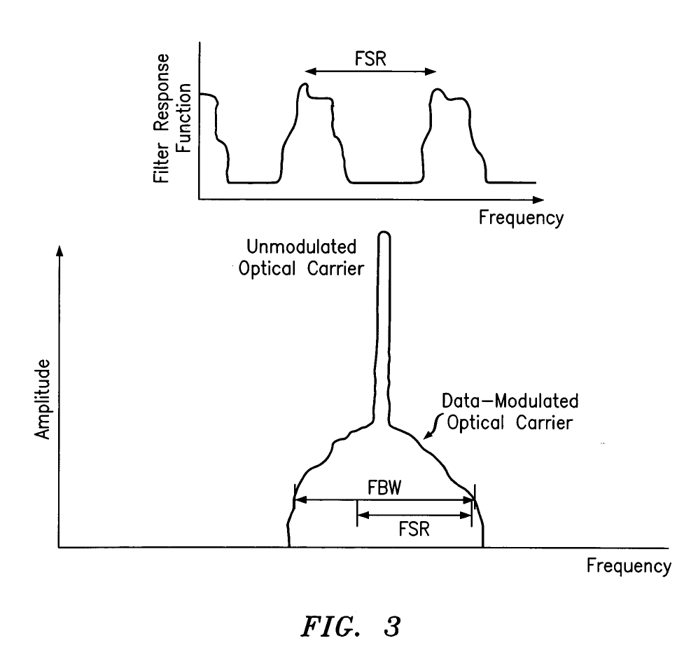

FIGS. 2A-2C qualitatively illustrate some potential forms for distortions that some embodiments of the dynamically reconfigurable optical filters 22, 24 are expected to produce. The illustrated distortions produce satellite copies (SC) of each original optical pulse (OP). In such distortions, each satellite copy (SC) may be temporally separated from its source optical pulse (OP) by, at least, the time between successive data symbols on the modulated optical carrier signal, i.e., the inverse of the data symbol rate. Since the satellite copies SC are separated from their source optical pulses (OP) by such large times, the satellite copies SC will strongly interfere with optical pulses for nearby digital data symbols. Thus, the satellite copies SC can make the original amplitude and/or phase data on said data-modulated optical carrier difficult to obtain by conventional demodulation schemes.

In contrast to conventional optical filters, which are configured to not substantially distort an optical signal's the data-carrying band, the dynamically reconfigurable optical filters 22, 24 of the optical transmitter 12 and receiver 14 are configured to substantial distort the data carrying band of the modulated optical carrier signal. For example, the optical filters 22, 24 have free spectral ranges (FSR) with unusual values and with unusual frequency dependencies to analog scramble a modulated optical carrier signal of the type output by the optical modulator 20.

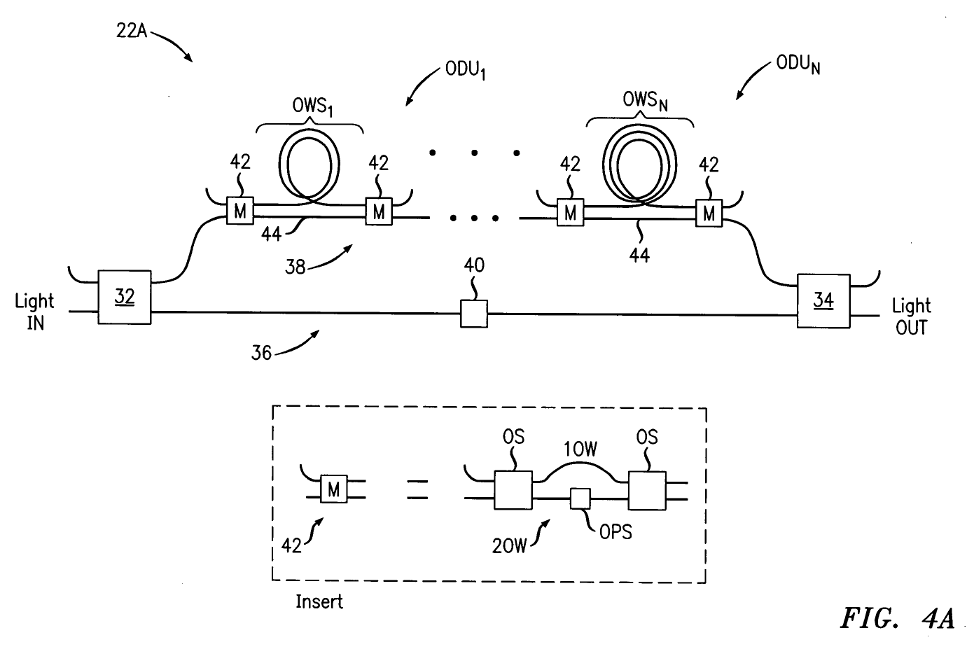

As qualitatively illustrated in FIG. 3, the optical filters 22, 24 may have filter response functions that vary substantially over the full bandwidth (FBW) at 3 decibel attenuation of the modulated optical carrier signal from the optical modulator 20.

As qualitatively illustrated in FIG. 3, the optical filters 22, 24 may have free spectral ranges (FSR) that are less than the full bandwidth FBW and are even less than half of that full bandwidth FBW. Such short free spectral ranges FSR may cause a region of substantial variation of the frequency response function to operate on the data-carrying band. Similar conclusions may follow if the free spectral ranges FSR of the optical filters 22, 24 are less than twice the data symbol rate of the optical transmitter 12 or are less than that data symbol rate itself.

The above-discussed two types of filter response functions and free spectral ranges FSR can enable the dynamically reconfigurable optical filters 22, 24 to produce large distortions of the modulated optical carrier signal from the optical modulator 20 of FIGS. 1A-1C. Such large distortions can provide a desirable large amount of analog optical scrambling of the optical data signal being transmitted.

The above-described analog optical scrambling may offer some advantages when an optical fiber transmission line supports optical phase shift keying. In particular, modulated optical carrier signals are typically difficult to store. Thus, an eavesdropper intercepting the scrambled modulated optical carrier signal might still not be able to unscramble the analog optical scrambling unless the eavesdropper knows the filter response function of the filter that produced the analog optical scrambling when the scrambled modulated optical carrier signal is intercepted. That is, an eavesdropper would probably not be able to easily unscramble such a scrambled optical carrier signal and obtain the data therefrom unless the eavesdropper had the filter's frequency response of a filter-configuration key defining the optical filter at the time that the optical signal is intercepted. Thus, dynamically varying the analog optical scrambling of the data symbol-modulated optical carrier signal may add to security in optical data communications.

Referring again to FIGS. 1A-1C, each optical communications systems 10A-10C uses a different technique to temporally coordinate the dynamically reconfigurable optical filters 22, 24 of the optical transmitter 12 and the optical receiver 14 to function in complementary manners.

Herein, a filter-configuration key includes data enabling a key-receiving device, e.g., the optical transmitter 12 or the optical receiver 14, to reconfigure the corresponding optical filter. Various embodiments use filter-configuration keys to ensure that the frequency response functions of the dynamically reconfigurable optical filters 22, 24 are changed without upsetting their complementary action.

In FIGS. 1A-1B, other communication media 2, 4, 6, 8, e.g., secure and low rate data links, transport synchronizing data for the dynamically reconfigurable optical filters 22, 24. The other communication media 2, 4, 6, 8 support, e.g., a secure communication of filter-configuration keys to the optical transmitter 12, the optical receiver 14, and/or both. In the optical communication system 10A of FIG. 1A, the filter-configuration keys may be transmitted over secure communication link 2 either from the optical transmitter 12 to the optical receiver 14 or from the optical receiver 14 to the optical transmitter 12. The receiving device 12 or 14 dynamically reconfigures its optical filter 22, 24 to be substantially complementary to a reconfigured form of the other device's optical filter 24, 22 based on the received filter-configuration key. In the optical communication system 10B of FIG. 1B, complementary pairs of filter-configuration keys are transmitted from an externally-located optical scrambling controller 4 to the optical transmitter 12 and the optical receiver 14 via secure and low data rate, links 6, 8. Then, the filter-configuration keys are used by the optical transmitter 12 and the optical receiver 14 to reconfigure their dynamically reconfigurable optical filters 22, 24 to have new and substantially complementary forms. That is, the externally-located, optical scrambling controller 4 remotely coordinates scrambling and unscrambling in the optical communication system 10B. In FIG. 1C, the optical transmitter 12 and optical receiver 14 have internal tables with preselected lists of complementary filter-configuration keys. The tables index the filter-configuration keys by use time-periods. Then, the optical transmitter 12 and the optical receiver 14 use filter-configuration keys from their local table to temporally synchronize reconfigurations of their dynamically reconfigurable optical filters 22, 24 in a manner that conserves the complementary of the action.

In various embodiments, dynamical reconfigurations of the optical filters 22, 24 may vary the periodicity and/or size of the phase and/or amplitude distortions produced thereby by more than an order of magnitude.

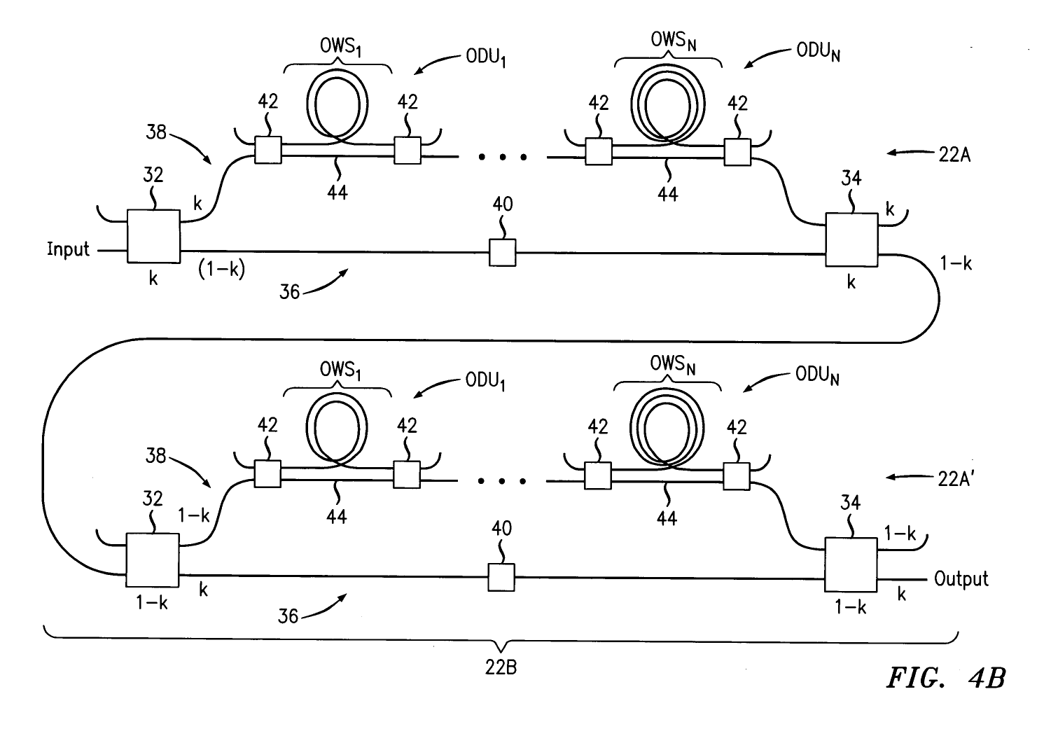

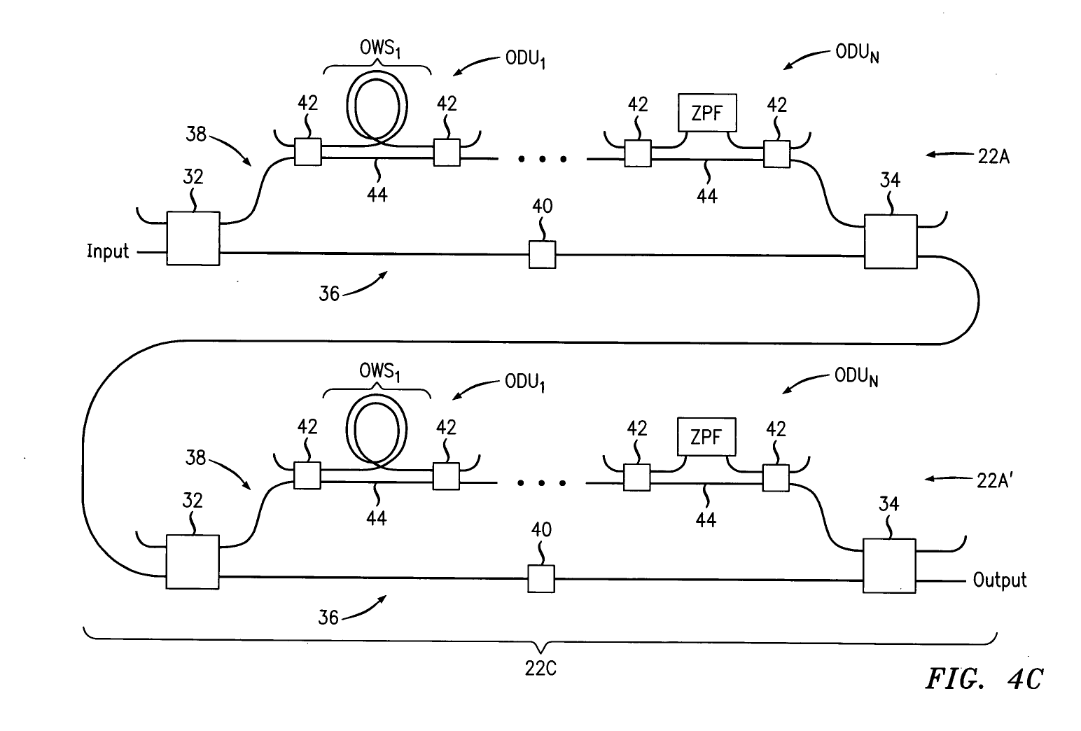

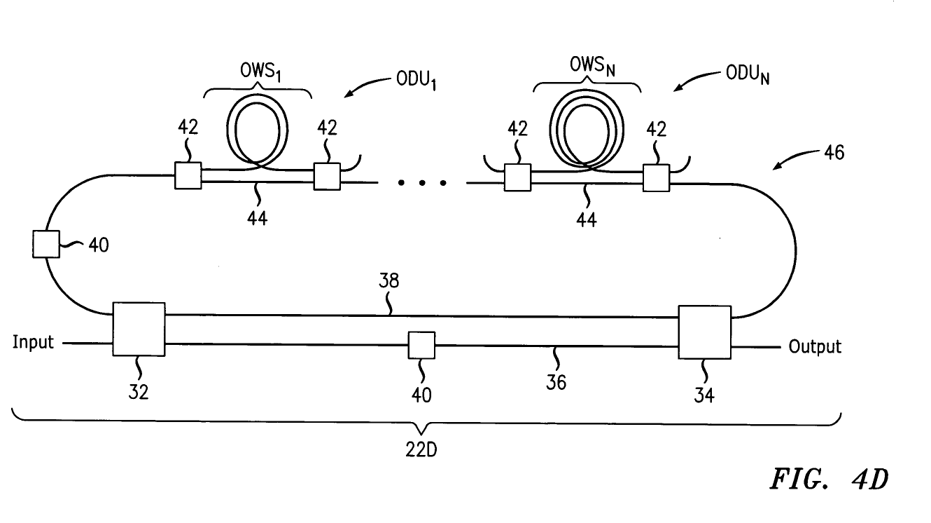

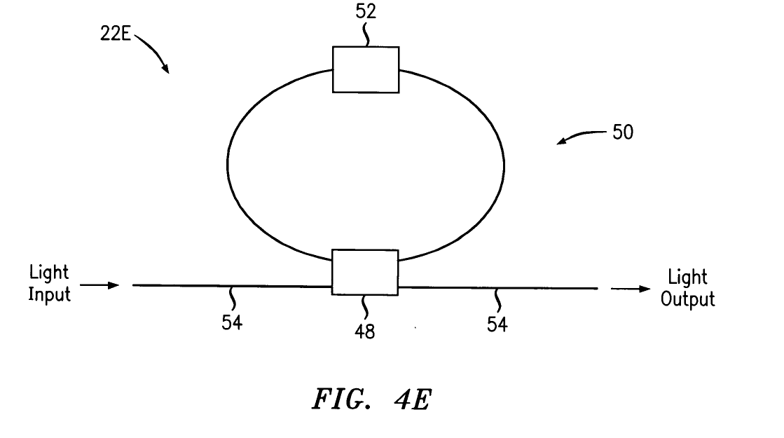

FIGS. 4A-4E schematically illustrate examples of dynamically reconfigurable optical filters 22A, 22B, 22C, 22D, 22E that may be suitable for the dynamically reconfigurable optical filters 22, 24 of FIGS. 1A-1C. In FIGS. 4A-4B, the dynamically reconfigurable optical filters 22A-22B have a tunable delay line in a feed forward configuration. In FIG. 4D, the dynamically reconfigurable optical filter 22D may have a feedback or autoregressive configuration. In FIG. 4E, the dynamically reconfigurable optical filter 22D has a resonant optical loop.

The dynamically reconfigurable optical filters 22A-22E may also be serially cascaded to form the dynamically reconfigurable optical filters 22, 24 of FIGS. 1A-1C.

Each dynamically reconfigurable optical filter 22A-22D has one or more internal optical waveguides whose optical path length(s) is (are) electrically, optically, or thermally modifiable. That is, these optical path lengths are dynamically reconfigurable. Modifying the optical path lengths of such internal optical waveguides can substantially modify these optical filter's free spectral ranges and frequency responses.

Herein, an optical waveguide whose optical path length may be dynamically reconfigured, e.g., to be longer or shorter, is referred to as a tunable optical delay line.

FIG. 4A illustrates a single-stage dynamically reconfigurable optical filter 22A of the form of an asymmetric MZI. The dynamically reconfigurable optical filter 22A includes a 1×2 or 2×2 optical power splitter 32, a 2×1 or 2×2 optical power combiner 34, and first and second internal optical waveguides 36, 38 connecting the optical outputs of the optical power splitter 32 to the optical inputs of the optical power combiner 34. The first internal optical waveguide 36 may include an optical phase shifter 40 operable to adjust the relative phase between light from the two internal optical waveguides 36, 38 in the optical power combiner 34. The second internal optical waveguide 38 is a tunable optical delay line. The optical power combiner 34 combines a light signal from the first internal optical waveguide 36 with temporally delayed and/or advanced copy thereof from the second internal optical waveguide 38.

The second internal optical waveguide 38 can produce a variety of optical path lengths between the optical splitter 32 and the optical combiner 34. In particular, the second optical waveguide 38 includes N serially concatenated optical delay units (ODU). Each optical delay unit ODU₁, . . . , ODU_{N} includes a pair of tunable MZI couplers 42 and an optical waveguide spiral OWS₁, . . . , OWS_{N}. The optical waveguide spirals OWS₁-OWS_{N} may have equal or different optical path lengths and can have various shapes, e.g., smooth curved spirals or spirals with corners. Each tunable MZI coupler 42 includes an optical splitter (OS), an optical combiner (OC), first and second optical waveguides (1OW, 2OW), and an optical phase shifter (OPS) as illustrated in the insert to FIG. 4A.

In each optical delay unit ODU₁-ODU_{N}, the pair of tunable MZI couplers 42 functions as a two-to-two switch having an ON-state and an OFF-state. In the ON-state, the pair of tunable MZI couplers 42 inserts the waveguide spiral WGS₁-WGS_{N} of the same optical delay unit ODU₁-ODU_{N} into the second internal optical waveguide 38. In the ON-state, the optical phase shifters OPS of the pair of tunable MZI couplers 42 are set to optically connect the second internal optical waveguide 38 to the optical waveguide spiral WGS₁-WGS_{N} of the optical delay unit ODU₁-ODU_{N}. In the OFF-state, the tunable MZI couplers 42 of the optical delay unit ODU₁-ODU_{N} decouple the optical waveguide spiral WGS₁-WGS_{N} of the optical delay unit ODU₁-ODU_{N} from the second internal optical waveguide 38 and insert a shorter shunt optical waveguide 44 into the second internal optical waveguide 38. In the OFF-state, the optical phase shifters OPS of the tunable MZI couplers 42 optically connect the second internal optical waveguide 38 to the shunt optical waveguide 44 of the optical delay unit ODU₁, . . . , ODU_{N}.

In response to receiving an optical signal or pulse OP, the dynamically reconfigurable optical filter 22A outputs a superposition of part of the optical signal or pulse OP and a satellite copy SC thereof. Such a superposition of multiple images of a received optical signal or pulse is one example of ripple distortion. The delay between the images depends on the optical path length of the second internal optical waveguide 38.

FIG. 4B schematically illustrates the dynamically reconfigurable optical filter 22B, which serially concatenates two dynamically reconfigurable optical filters 22A, 22A′ as shown in FIG. 4A. The optical path lengths of various optical waveguide spirals WGS₁-WGS_{N} may be different in one or both of the concatenated dynamically reconfigurable optical filters 22A, 22A′. For example, the P-th optical waveguide spiral WGS_{P} may be K2^{P} where K is a constant so that each possible optical path length of the second internal optical waveguide 38 corresponds to a binary coded optical path length.

In the dynamically reconfigurable optical filter 22B, the component dynamically reconfigurable optical filters 22A, 22A′ may have the same or different sets of optical delay units ODU₁-ODU_{N}, e.g., the same or different lengths, shapes, and/or numbers of optical waveguide spirals WGS₁-WGS_{N}.

In the dynamically reconfigurable optical filter 22B, the component dynamically reconfigurable optical filters 22A, 2A′ may have optical splitters 32 and optical combiners 34 that symmetrically or asymmetrically distribute optical powers between optical outputs. In addition, the two dynamically reconfigurable optical filters 22A, 22A′ may transmit different fractions of the received optical power to their second internal optical waveguides 38. For example, the first and second dynamically reconfigurable optical filters 22A and 22A′ may transmit respective fractions “k” and “1−k” of the received optical power to their second internal optical waveguide 38 and remainders thereof to their first internal optical waveguides 36 as schematically illustrated.

In response to receiving an optical signal or pulse OP, the dynamically reconfigurable optical filter 22B outputs a superposition that includes a part of the received optical signal or pulse OP and multiple satellite copies SC thereof, e.g., two or more satellite copies SC. For example, the superposition can have a form as schematically illustrated in one of FIGS. 2A-2B.

FIG. 4C schematically illustrates the dynamically reconfigurable optical filter 22C, which is similar to the dynamically reconfigurable optical filter 22B of FIG. 4B. Both dynamically reconfigurable optical filters 22B, 22C are serial concatenations of simpler optical filters, but, the component optical filters 22A, 22A′ have second internal optical waveguides 38 that differ in one optical delay unit ODU_{N} therein. In the dynamically reconfigurable optical filters 22C, the last optical delay units ODU_{N} are conventional zero-pole optical filters (ZPF), which may provide substantially continuous tuning of the optical delay. The zero-pole optical filter ZPF may include an optical waveguide with one or more controllable couplings to resonant optical waveguide loops.

The dynamically reconfigurable optical filter 22C may also output a superposition that includes a part of a received optical signal or pulse OP and copies SC thereof, e.g., two or more satellite copies SC. For example, the resulting superposition can have the form schematically illustrated in one of FIGS. 2A-2B.

FIG. 4D schematically illustrates the dynamically reconfigurable optical filter 22D, which may operate as a moving average filter. The dynamically reconfigurable optical filter 22D includes a 2×2 optical power splitter 32, a 2×2 optical power combiner 34, first and second optical waveguides 36, 38, and an optical feedback loop 46. The optical power splitter and combiner 32, 34 may symmetrically or asymmetrically distribute optical power to their optical outputs. The first and second optical waveguides 36, 38 connect the optical outputs of the optical splitter 32 to the optical inputs of the optical combiner 34. The optical feedback loop 46 connects an optical output of the 2×2 optical combiner 34 to an optical input of the 2×2 optical splitter 32. The optical feedback loop 46 has a sequence of optical delay units ODU₁-ODU_{N} with the structure of the optical delay units ODU₁, . . . , ODU_{N} of FIGS. 4A-4C. The dynamically reconfigurable optical filter 22D can produce a superposition that is a long sequence of time-delayed satellite copies SC of a received optical pulse OP.

FIG. 4E schematically illustrates a dynamically reconfigurable optical filter 22E that includes dynamically reconfigurable optical coupler 48 and resonant optical waveguide loop 50. The dynamically reconfigurable optical coupler 48 can be operated to vary a fraction of the input light from the input/output optical waveguide 54 that couples into the resonant optical waveguide loop 50. The resonant optical waveguide loop 50 includes a dynamically reconfigurable optical delay line 52 that enables its optical path length to be dynamically changed.

The optical communication systems 10A-10C of FIGS. 1A-1C can provide analog optical scrambling, which is qualitatively different than many conventional forms of encryption. Typically, an analog-scrambled optical carrier is difficult to store due to a limited temporary optical storage capacity. In some embodiments, storing the analog scrambled optical signals of the optical communications systems 10A-10C may require more such capacity due to the presence of both intensity and phase distortion. Thus, such analog scrambled optical signals are typically secure from eavesdroppers not having real-time knowledge of the form of the distortion used for the analog optical scrambling.

Even though an optical filter with a continually tunable optical delay line may be used to determine the distortion settings for such analog optical scrambling, the time to find the filter settings may be large due to a continuum of possibilities. Dynamically resetting the analog optical scrambling at a reasonable rate may be sufficient to stop many eavesdroppers from finding the form of the optical scrambling and unscrambling a substantial portion of the scrambled modulated optical carrier signal.

In various embodiments, the optical communications systems 10A-1C analog optically scramble data communications in a new physical dimension. Thus, such analog optical scrambling-security can be used in addition to known encryption. Thus, this new analog optical scrambling may provide an added level of security.

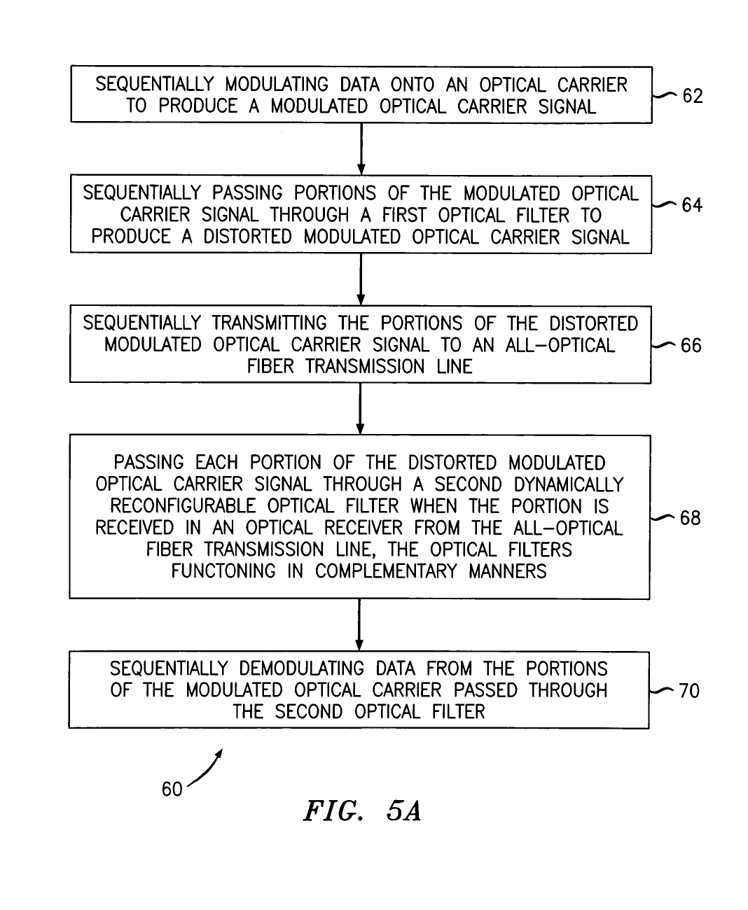

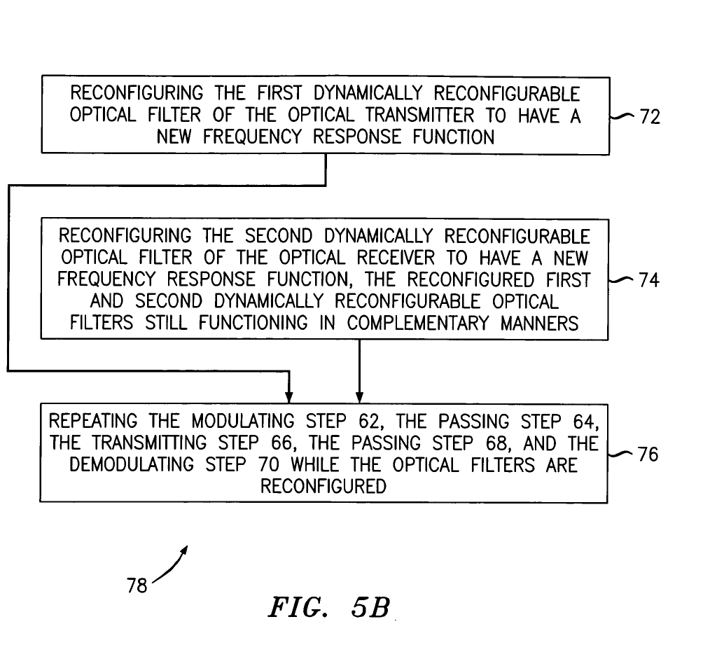

FIG. 5A illustrates a method 60 of optically communicating data over an all-optical link, e.g., the all-optical link of any of FIGS. 1A-1C.

The method 60 includes sequentially modulating data onto an optical carrier via a phase-keyed modulation protocol to produce a modulated optical carrier signal (step 62). The modulating step 62 modulates data symbols onto the optical carrier at a preselected data symbol rate, e.g., in the optical modulator 20 of any of FIGS. 1A-1C.

The method 60 includes sequentially passing portions of the modulated optical carrier signal through a first dynamically reconfigurable optical filter to produce a distorted modulated optical carrier signal, e.g., in the dynamically reconfigurable optical filter 22 of any of FIGS. 1A-1C (step 64). The first optical filter scrambles the portions of the modulated optical carrier signal and may provide security for data therein.

The method 60 includes sequentially transmitting the portions of the distorted modulated optical carrier signal to an all-optical fiber transmission line, e.g., the all-optical fiber transmission line 16 of any of FIGS. 1A-1C (step 66). The all-optical fiber transmission line connects the optical transmitter to an optical receiver, e.g., the optical receiver 14 of any of FIGS. 1A-1C. The all-optical fiber transmission line may have one or more optical fiber spans, e.g., connected by conventional optical amplifiers.

The method 60 includes passing each portion of the distorted modulated optical carrier signal through a second dynamically reconfigurable optical filter when the portion is received in the optical receiver from the all-optical fiber transmission line (step 68). This second dynamically reconfigurable optical filter sequentially optically unscrambles the portions of the distorted modulated optical carrier signal as received at the optical receiver. The second dynamically reconfigurable optical filter may be, e.g., the dynamically reconfigurable optical filter 24 of any of FIGS. 1A-1C.

The first and second dynamically reconfigurable optical filters are maintained in configurations that will function in complementary manners on the individual portions of the modulated optical carrier signal.

In some embodiments, the first and second dynamically reconfigurable optical filters may have free spectral ranges that are less than the data symbol rate or are less than half thereof. The first and second dynamically reconfigurable optical filters may have frequency response functions that vary substantially over the full bandwidth at 3 decibel attenuation of the modulated optical carrier signal and/or may cause a frequency dependent phase ripple with a peak-to-peak phase variation of a ½ radian or more.

The method 60 includes sequentially demodulating data from the portions of the modulated optical carrier passed through the second dynamically reconfigurable optical filter, at step 68, to retrieve part or all of the data carried thereon (step 70). Since the second dynamically reconfigurable optical filter substantially removed the analog optical scrambling, e.g., except for attenuation, nonlinear optical, and dispersion degradations. The portions of modulated optical carrier signal from the second dynamically reconfigurable optical filter can be demodulated by conventional data demodulators.

In a specific embodiment 78 of the method 60, additional steps involve dynamically reconfiguring the analog optical scrambling as illustrated in FIG. 5A.

The additional steps include reconfiguring the first dynamically reconfigurable optical filter of the optical transmitter to have a new frequency response function (step 72). The new frequency response function is substantially different from the filter's earlier frequency response function, e.g., has a large percentage variation over the 3 dB bandwidth of the modulated optical carrier signal of data modulation step 62.

The additional steps include reconfiguring the second dynamically reconfigurable optical filter of the optical receiver to have a new frequency response function (step 74). The reconfiguring steps 72-74 are coordinated so that the first and second dynamically reconfigurable optical filters still act in complementary manners on corresponding portions of the modulated optical carrier signal. Thus, the analog optical scrambling that the first dynamically reconfigurable optical filter causes to a portion of the modulated optical carrier signal is substantially removed the action of by the second dynamically reconfigurable optical filter on the same portion of the modulated optical carrier signal.

In some embodiments, the reconfiguring steps 72-74 include transmitting a filter-configuration key either from the optical transmitter to the optical receiver or from the optical receiver to the optical transmitter. The filter-configuration key is selected to enable to optical device receiving the key to reconfigure its dynamically reconfigurable optical filter to be complementary to the reconfigured form of the dynamically reconfigurable optical filter of the optical device transmitting the key.

In some alternate embodiments, the reconfiguring steps 72-74 include receiving filter-reconfiguration keys at the optical transmitter and optical receiver from an external controller, e.g., via data links 6, 8 from the external controller 4 of FIG. 1B. In such embodiments, the reconfiguring steps 72-74 are performed in response to receiving filter-configuration keys from the external controller at the optical transmitter and the optical receiver. That is, the filter-configuration keys fix the reconfigured forms of the first and second dynamically reconfigurable optical filters, and the keys are selected to ensure that the reconfigured forms correspond to complementary optical filters.

In other alternate embodiments, the reconfiguring steps 72-74 may include looking up filter-configuration keys in tables stored locally in the optical transmitter and the optical receiver. Then, the optical transmitter and optical receiver use their locally stored filter-configuration keys to reconfigure their dynamically reconfigurable optical filters. The tables are coordinated so that keys for complementary filters are always used to process individual portions of the modulated optical carrier signal. For example, each locally stored table may have use-times indexing its filter-configuration keys so that the filter-configuration keys for the optical transmitter and the optical receiver are selected in a temporally synchronized way. Such table indexing can cause the optical transmitter and optical receiver to have complementary functioning optical filters at all times.

The further steps may include then, repeating the modulating step 62, the passing step 64, the transmitting step 66, the passing step 68, and the demodulating step 70 while the dynamically reconfigurable optical filters are reconfigured according to the steps 72-74 (step 76). During this step 76, the form of the distortion that scrambles portions of the modulated optical carrier signal during optical transmission is different from the form of the distortion used to scramble other portions of the modulated optical carrier signal during the earlier optical transmission of step 66, i.e., the scrambling distortion has been dynamically varied. Both scramblings may distort the phase and/or the amplitude of the modulated optical carrier signal to be substantially unreadable via conventional demodulation techniques, i.e., prior to unscrambling. For example, such an analog-scrambled modulated optical carrier signal may be unreadable without knowledge of the filter-configuration keys defining the form of analog-scrambling.

### Example Dynamically Reconfigurable Optical Filter

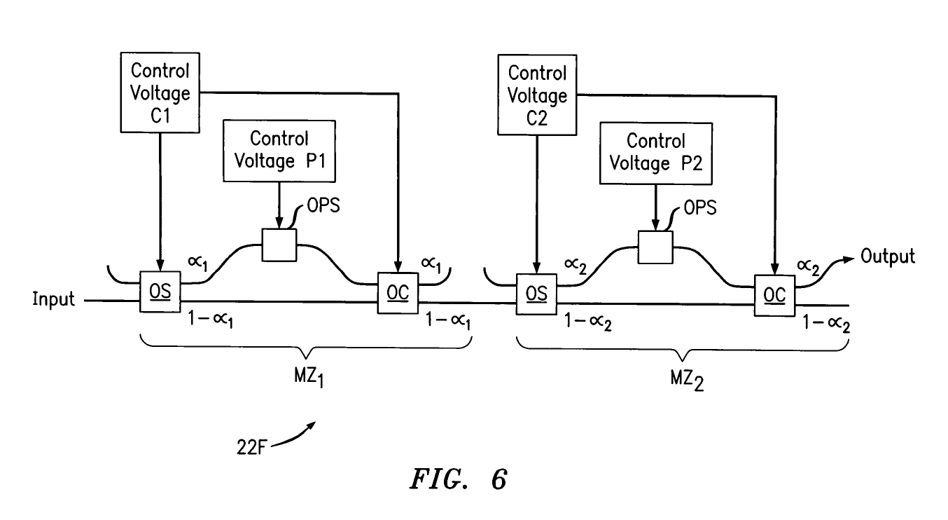

The dynamically reconfigurable optical filters 22, 24 of FIGS. 1A-1C may also have the form of a dynamically reconfigurable optical filter 22F of FIG. 6. The dynamically reconfigurable optical filter 22F can be configured to provide substantial phase distortion with a low associated amplitude distortion.

The dynamically reconfigurable optical filter 22F is a serial cascade of Mach-Zehnder interferometers MZ₁, MZ₂. Each Mach-Zehnder interferometer MZ₁, MZ₂ is defined by power coupling ratios of its optical couplers, i.e., α₁ and α₂, and relative phases for light from its internal optical waveguides, i.e., φ₁ and φ₂. For an optical coupler with two outputs, the power coupling ratio α is the ratio of the portion of incident optical power transmitted to its first optical output over the portion of the incident optical power transmitted to its second optical output. For two internal optical waveguides of a Mach-Zehnder interferometer, the relative phase φ is the phase delay of light output by a first of the internal optical waveguides relative to the phase of the light output by the second of the internal optical waveguides.

In the dynamically reconfigurable optical filter 22F, control voltages fix the power coupling ratios α₁ and α₂ and phase shifts φ₁ and φ₂ of the Mach-Zehnder interferometers MZ₁, MZ₂. The power coupling ratios α₁ and α₂ of the first and second Mach-Zehnder interferometers MZ₁ and MZ₂ are controlled by voltages P1 and P2, respectively. The phase shifts φ₁ and φ₂ of the first and second Mach-Zehnder interferometer MZ₁ and MZ₂ can be controlled by respective control voltages C1 and C2.

The dynamically reconfigurable optical filter 22F has a frequency response function R(ω), which can be approximately written as, i.e., up to an overall phase:

$$R ( ω ) = ( 1 - {α}_{1} ) ( 1 - {α}_{2} ) + {α}_{1} {α}_{2} exp ( i {φ}_{1} - {iφ}_{2} ) - {α}_{1} ( 1 - {a}_{2} ) exp [ {iφ}_{1} + i ( ω - {ω}_{0} ) τ ] - {α}_{2} ( 1 - {α}_{1} ) exp [ - {iφ}_{2} - i ( ω - {ω}_{0} ) τ ] \qquad ( 1 )$$

Here, τ is the time delay of each serially concatenated and dynamically reconfigurable optical filter MZ₁, MZ₂, i.e., the inverse of the free spectral range FSR of the Mach-Zehnder interferometers MZ₁, MZ₂, and ω₀ is a central operating frequency of these devices at which are defined by the α and φ parameters. In some embodiments,

$${ω}_{0} / ( 2 π )$$

may be a standard ITU grid frequency such as 193 THz.

In the dynamically reconfigurable optical filter 22F, the power coupling ratios α₁ and α₂ and phase shifts φ₁ and φ₂ can be selected to produce analog optical scrambling with a low amplitude ripple and a substantial phase ripple, e.g., to generate group delay ripple for optical pulses without large attenuation. The power coupling ratios and phase shifts can be selected as follows:

α₂=α₁ and (2)

φ₂=φ₁+ρ. (3)

If above-conditions (2) and (3) are satisfied, the frequency response function R(ω) of equation (1) simplifies to:

R(ω)=(1−2α₁)−i2α₁(1−α₁)sin [φ₁+(ω−ω₀)τ]. (4)

Then, the amplitude and phase of the frequency response function, R(ω), are given by:

$$\begin{matrix}\begin{matrix}{\vert R ( ω ) \vert}^{2} = {( 1 - 2 {α}_{1} )}^{2} + 4 {{α}_{1}^{2} ( 1 - {a}_{1} )}^{2} {sin}^{2} [ {φ}_{1} + ( ω - {ω}_{0} ) τ ] , & \end{matrix} & ( 5 ) \\ φ ( ω ) = {tan}^{- 1} \{ - \frac{2 {α}_{1} ( 1 - {α}_{1} )}{1 - 2 {α}_{1 }} sin [ {φ}_{1} + ( ω - {ω}_{0} ) τ ] \} \approx - \frac{2 {α}_{1} ( 1 - {α}_{1} )}{1 - 2 {α}_{1}} sin [ {φ}_{1} + ( ω - {ω}_{0} ) τ ] . & ( 6 )\end{matrix}$$

In equation (6), the last line is based on the approximation tan⁻¹ x≈x and an assumption that α₁ is small. In such an approximation, equation (6) implies that the group delay GD(ω) is:

$$GD ( ω ) = \frac{d φ ( ω )}{d ω} \approx - \frac{2 {α}_{1} ( 1 - {α}_{1} ) τ}{1 - 2 {α}_{1}} cos [ {φ}_{1} + ( ω - {ω}_{0} ) τ ] . \qquad ( 7 )$$

From equation (8), the frequency of the group delay ripple (GDR) is 1/τ, and the peak-to-peak GDR is approximately given by:

$${GDR}_{p - p} \approx \frac{4 {α}_{1} ( 1 - {α}_{1} )}{1 - 2 {α}_{1}} τ . \qquad ( 8 )$$

Thus, the peak-to-peak group delay GDRₚ₋ₚ can be adjusted with the power coupling ratio α₁.

In equation (7), the phase shift φ₁ translates the group delay curve in frequency ω₀. The cases of Φ₁=0 and φ₁=ρ or correspond to respective maximum and maximum group delay at the frequency

$${ω}_{0} / ( 2 π ) .$$

Also, the frequency dependence of the group delay has a period that depends on the filter's delay time τ.

In light of the above-disclosure, a person of skill in the art could find values of α₁, Φ₁, and τ for which the dynamically reconfigurable optical filter 22F provides an approximately optimal frequency-dependent group delay. For example, values of φ₁ and τ can be selected to produce a group delay of maximal amplitude for a selected sequence of optical channels that are approximately regularly spaced in frequency. Then, the value of α₁ can be selected so that the magnitude of the group delay has a desired value for the selected sequence of optical channels. Indeed, the value of α₁ may be varied in time to dynamically change the size of the analog optical scrambling of phase that such embodiments of the dynamically reconfigurable optical filter 22F would provide. Applicants expect that the dynamically reconfigurable optical filter 22F could be setup to produce a frequency-dependent phase delay with a peak-to-peak difference of 0.5 or more radians or even 1.0 or more radians.

The invention is intended to include other embodiments that would be obvious to one of skill in the art in light of the description, figures, and claims.

What we claim is:

1. An apparatus comprises:
an optical transmitter having a first dynamically reconfigurable optical filter;
an optical receiver having a second dynamically reconfigurable optical filter; and
wherein the optical transmitter and the optical receiver are connected by an optical fiber transmission line and the dynamically reconfigurable optical filters are configured to function in a complementary manner.

2. The apparatus of claim 1, wherein one of the dynamically reconfigurable optical filters has a free spectral range that is less than the data symbol rate of the optical transmitter.

3. The apparatus of claim 1, wherein one of the dynamically reconfigurable optical filters has a frequency response function that varies substantially over the full bandwidth at 3 decibel attenuation of a data-modulated carrier signal produced by the optical transmitter.

4. The apparatus of claim 1, wherein one of the dynamically reconfigurable optical filters has a frequency response function that can be substantially dynamically varied over the full bandwidth at 3 decibel attenuation of a data-modulated carrier signal produced by the optical transmitter.

5. The apparatus of claim 1, wherein the optical transmitter is configured transmit filter-configuration keys to the optical receiver.

6. The apparatus of claim 1, wherein the optical receiver is configured transmit filter-configuration keys to the optical transmitter.

7. The apparatus of claim 1, further comprising:
an external controller configured to transmit filter-configuration keys to the optical transmitter and the optical receiver; and
wherein each of the optical transmitter and the optical receiver is configured to reconfigure the dynamically reconfigurable optical filter thereof in response to receiving one of the filter-configuration keys from the external controller.

8. The apparatus of claim 1, wherein one of the dynamically reconfigurable optical filters includes a Mach-Zehnder interferometer with an internal optical waveguide that is a dynamically variable optical delay line.

9. The apparatus of claim 1, wherein one of the dynamically reconfigurable optical filters includes an optical splitter, an optical combiner and first and second internal optical waveguides, the first internal optical waveguide connecting an output of the optical splitter to an input of the optical combiner, the second internal optical waveguide being a variable optical delay line connecting an output of the optical combiner to an input of the optical splitter.

10. The apparatus of claim 1, wherein one of the dynamically reconfigurable optical filters is able to generate a phase ripple having a peak-to-peak phase variation of a ½ radian or more.

11. A method of communicating optically, comprising:
at a data symbol rate, modulating data symbols onto an optical carrier according to a phase-keyed modulation protocol, the modulating sequentially producing portions of a modulated optical carrier signal;
sequentially passing the portions of the modulated optical carrier signal through a first dynamically reconfigurable optical filter to sequentially produce portions of a distorted modulated optical carrier signal;
sequentially transmitting the portions of the distorted modulated optical carrier signal to an optical fiber transmission line;
sequentially passing portions of the distorted modulated optical carrier signal through a second dynamically reconfigurable optical filter in response to receiving the portions in an optical receiver connected to the optical fiber transmission line; and
wherein the first and second dynamically reconfigurable optical filters are configured to function in complementary manners.

12. The method of claim 11, wherein one of the dynamically reconfigurable optical filters has a free spectral range that is less than the data symbol rate.

13. The method of claim 11, wherein one of the dynamically reconfigurable optical filters has a frequency response function that varies substantially over the full bandwidth at 3 decibel attenuation of the modulated carrier signal produced by the optical transmitter.

14. The method of claim 11, further comprising:
reconfiguring the dynamically reconfigurable optical filter of one of the optical transmitter and the optical receiver to have a new frequency response function; and
reconfiguring the dynamically reconfigurable optical filter of the other of the optical transmitter and the optical receiver to have a new frequency response function; and
wherein the reconfigured dynamically reconfigurable optical filter of the optical transmitter functions in a complementary manner with respect to the reconfigured dynamically reconfigurable optical filter of the optical receiver.

15. The method of claim 14,
further comprising transmitting a filter-configuration key from the one of the optical transmitter and the optical receiver to the other of the optical transmitter and the optical receiver; and
wherein the reconfiguring the dynamically reconfigurable optical filter of the other of the optical transmitter and the optical receiver is performed responsive to receiving the filter-configuration key in the other of the optical transmitter and the optical receiver.

16. The method of claim 14, wherein the reconfiguring steps are performed in response to receiving filter-configuration keys from an external controller at the optical transmitter and the optical receiver.

17. The method of claim 14, further comprising repeating the modulating, passing, and transmitting acts while the dynamically reconfigurable optical filters are reconfigured.

18. The method of claim 11, wherein each dynamically reconfigurable optical filter includes a Mach-Zehnder interferometer with an internal optical waveguide that is a dynamically variable optical delay line.

19. The method of claim 11, wherein each dynamically reconfigurable optical filter includes an optical splitter, an optical combiner and first and second internal optical waveguides, the first internal optical waveguide connecting an output of the optical splitter to an input of the optical combiner, the second internal optical waveguide being a variable optical delay line connecting an output of the optical combiner to an input of the optical splitter.

20. The method of claim 11, wherein one of the dynamically reconfigurable optical filters is configured to generate a phase ripple having a peak-to-peak phase variation of a ½ radian or more.
